(19) United States
(12) Patent Application Publication
(10) Pub. No.: US 2007/0083777 A1
(43) Pub. Date: Apr. 12, 2007

(54) Information processing apparatus and power on control method

(76) Inventor: Toshikazu Morisawa, Tokorozawa-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/522,153

(22) Filed: Sep. 15, 2006

(30) Foreign Application Priority Data
Oct. 7, 2005 (JP) 2005-295139
Jul. 7, 2006 (JP) 2006-188422

(51) Int. Cl. G06F 1/00

(52) U.S. Cl. 713/300

(57) ABSTRACT

According to one embodiment, there is provided an information processing apparatus including a controller configured to permit an automatic power-on of the apparatus, and a device configured to be manually operated to interrupt the automatic power-on of the apparatus.

### CROSS-REFERENCE TO RELATED APPLICATIONS

This application is based upon and claims the benefit of priority from prior Japanese Patent Applications No. 2005-295139, filed Oct. 7, 2005; and No. 2006-188422, filed Jul. 7, 2006, the entire contents of which are incorporated herein by reference.

### BACKGROUND

1. Field

One embodiment of the invention relates to an information processing apparatus having an automatic power on function and a power on control method.

2. Description of the Related Art

Generally, an information processing apparatus, such as a personal computer, has a resume function of restoring the system to a condition as was immediately before the power is turned off.

For example, Jpn. Pat. Appln. KOKAI Publication No. 10-20972 discloses portable information equipment, which can set the aforementioned resume function enable or disable, at the same time as the power-off operation.

There are two types of resume function: a manual resume function and an automatic resume function. The manual resume function causes the system to be restored according to a manual power-on operation. The automatic resume function causes the system to automatically power on the apparatus and restore when a predetermined condition is satisfied (for example, when a current time coincides with a preset time).

The automatic resume function is generally convenient, because the system can be automatically resumed when the condition set by the user is satisfied, even if the user does not realize that. However, depending on the circumstances, the user may not wish the system to be automatically resumed. To avoid the automatic resume function from being performed, the user may turn off the information processing apparatus, activate an application relating to the resume function, open the application setting screen, and change the setting to disable the automatic resume function. This process is complicated and troublesome for the user. The same can be said for an automatic boot up function which causes the system to be automatically boot up from an OFF state.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing a state in which a display unit of a computer according to an embodiment of the invention is opened;

FIG. 2 is an exemplary block diagram showing a system configuration of the computer;

FIG. 3 is an exemplary block diagram showing a first configuration example of a part relating to resume processing in the computer;

FIG. 4 is an exemplary diagram showing the relationship between a state of an automatic resume inhibit switch and a state of a resume function;

FIG. 5 is an exemplary diagram showing an example of a switch mechanism (ON state) in the first configuration example;

FIG. 6 is an exemplary diagram showing an example of the switch mechanism (OFF state) in the first configuration example;

FIG. 7 is an exemplary flowchart showing an operation flow in the first configuration example;

FIG. 8 is an exemplary block diagram showing a second configuration example of a part relating to resume processing in the computer;

FIG. 9 is an exemplary diagram showing an example of a switch mechanism (ON state) in the second configuration example;

FIG. 10 is an exemplary diagram showing an example of the switch mechanism (OFF state) in the second configuration example;

FIG. 11 is an exemplary flowchart showing an operation flow in the second configuration example;

FIG. 12 is an exemplary block diagram showing a third configuration example of a part relating to boot up processing-in the computer;

FIG. 13 is an exemplary diagram showing the relationship between a state of an automatic boot up inhibit switch and a state of a boot up function;

FIG. 14 is an exemplary diagram showing an example of a switch mechanism (ON state) in the third configuration example;

FIG. 15 is an exemplary diagram showing an example of the switch mechanism (OFF state) in the third configuration example;

FIG. 16 is an exemplary flowchart showing an operation flow in the third configuration example;

FIG. 17 is an exemplary block diagram showing a fourth configuration example of a part relating to boot up processing in the computer;

FIG. 18 is an exemplary diagram showing an example of a switch mechanism (ON state) in the fourth configuration example;

FIG. 19 is an exemplary diagram showing an example of the switch mechanism (OFF state) in the fourth configuration example; and

FIG. 20 is an exemplary flowchart showing an operation flow in the fourth configuration example.

### DETAILED DESCRIPTION

Various embodiments according to the invention will be described hereinafter with reference to the accompanying drawings. In general, according to one embodiment of the invention, there is provided an information processing apparatus including a controller configured to permit an automatic power-on of the apparatus, and a device configured to be manually operated to interrupt the automatic power-on of the apparatus.

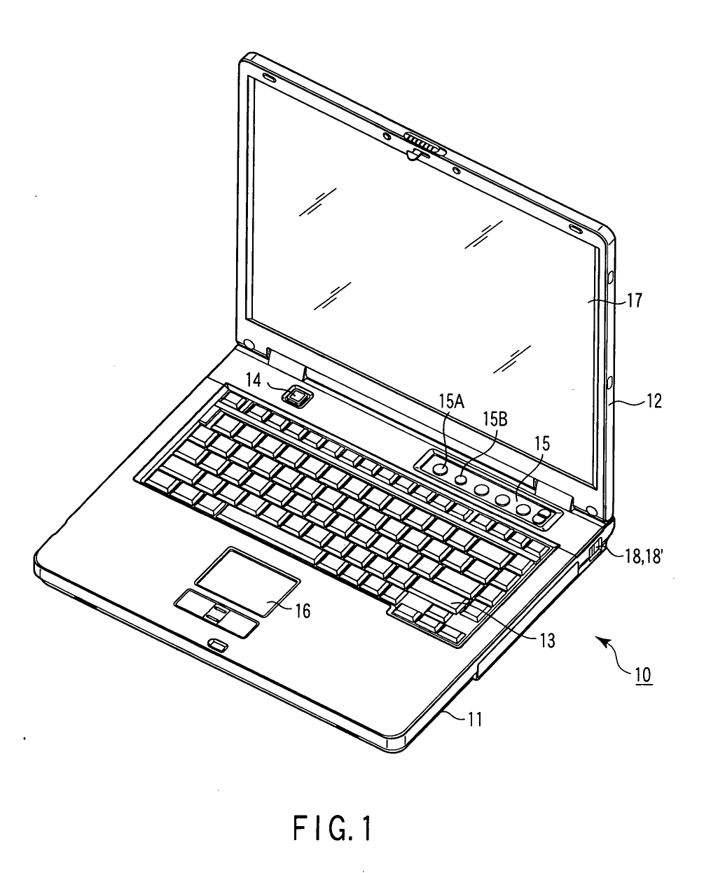

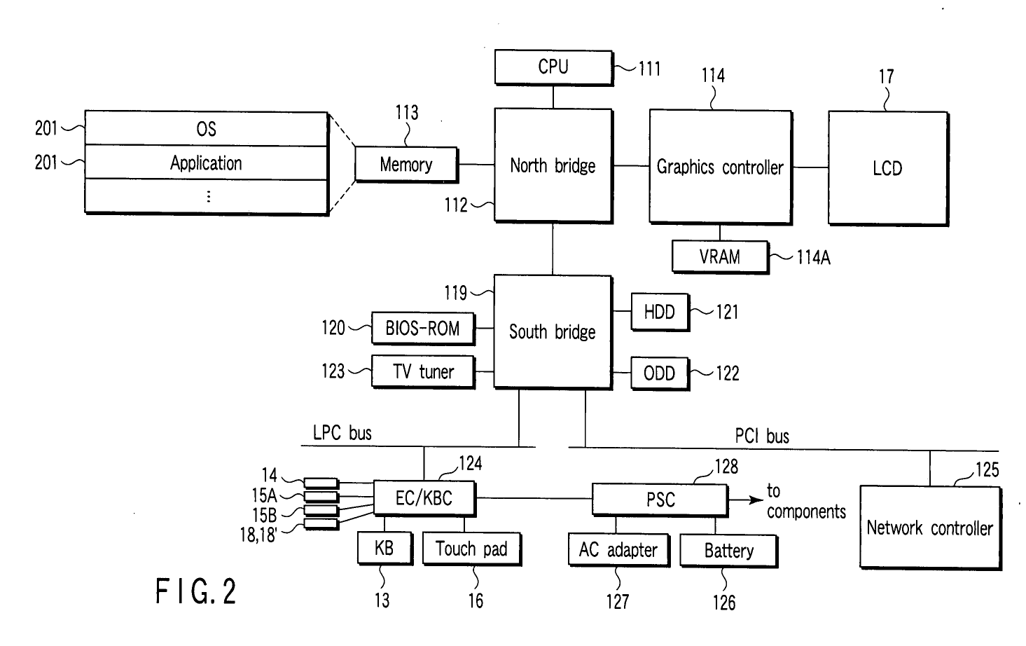

First, a configuration of an information processing apparatus according to an embodiment of the invention will be described with reference to FIGS. 1 and 2. The information processing apparatus is implemented as, for example, a notebook computer 10.

FIG. 1 is a perspective view showing a state in which a display unit of the notebook computer 10 is opened. The computer 10 comprises a housing including a computer main body 11 and a display unit 12. The display unit 12 incorporates a display device comprising a TFT-LCD (Thin Film Transistor Liquid Crystal Display) 17. A display screen of the LCD 17 is located in a substantially central portion of the display unit 12.

The display unit 12 is attached to the computer main body 11 so as to be rotatable between an opened position and a closed position. The computer main body 11 has a thin box-shaped casing. The computer main body 11 comprises a keyboard 13, a power button 14 to power on/off the computer 10, an input operation panel 15, a touch pad 16, an automatic resume inhibit switch 18, an automatic boot up inhibit switch 18′ etc., which are arranged on an upper surface of the casing. In this embodiment, the apparatus has two switching devices for enable/disabling automatic power-on function. The automatic resume inhibit switch 18 and the automatic boot up inhibit switch 18′ may be positioned on the housing separately, or may be unified both functions into one switch and positioned thereon as a single switch.

The input operation panel 15 is an input device, through which an event corresponding to a depressed button is input. It has a plurality of buttons to activate a plurality of functions, respectively. The group of buttons includes a TV activating button 15A and a DVD/CD activating button 15B. The TV activating button 15A is a button to activate TV function in order to play back, view, listen to and record TV broadcast program data. The DVD/CD activating button 15B is a button to play back video contents recorded in a DVD or CD.

The automatic resume inhibit switch 18 is provided, for example, on a side of the computer main body 11 of the computer 10. This is an operation switch to enable or disable the automatic resume function of the computer 10 (one kind of the automatic power on function enabling automatically power on and restoring the system to a condition as was immediately before the power is turned off when a predetermined condition is satisfied). Details of the automatic resume inhibit switch 18 will be described later.

The automatic boot up inhibit switch 18′ is provided, for example, on a side of the computer main body 11 of the computer 10. This is an operation switch to enable or disable the automatic boot up function of the computer 10 (one kind of the automatic power on function enabling automatically power on and initializing the system when a predetermined condition is satisfied). Details of the automatic boot up inhibit switch 18′ will be described later.

A system configuration of the computer 10 will now be described with reference to FIG. 2.

As shown in FIG. 2, the computer 10 comprises a CPU 111, a north bridge 112, a main memory 113, a graphics controller 114, a south bridge 119, a BIOS-ROM 120, a hard disk drive (HDD) 121, an optical disk drive (ODD) 122, a TV tuner 123, an embedded controller/keyboard controller IC (EC/KBC) 124, a network controller 125, a battery 126, an AC adapter 127, a power supply controller (PSC) 128, etc.

The CPU 111 is a processor provided to control operations of the computer 10. It executes an operating system (OS) 200 and various application programs 201 loaded from the hard disk drive (HDD) 121 to a main memory 113.

The CPU 111 also executes a system BIOS stored in the BIOS-ROM 120. The system BIOS is a program for hardware control.

The north bridge 112 is a bridge device which connects the south bridge 119 with a local bus of the CPU 111. The north bridge 112 incorporates a memory controller which controls access to the main memory 113. Further, the north bridge 112 has a function for executing communications with the graphics controller 114 via an accelerated graphics port (AGP) bus.

The graphics controller 114 is a display controller, which controls an LCD 17 used as a display monitor of the computer 10. The graphics controller 114 displays video data written in a video memory (VRAM) 114A on the LCD 17.

The south bridge 119 controls devices on a low pin count (LPC) bus and devices on a peripheral component interconnect (PCI) bus. The south bridge 119 incorporates an integrated drive electronics (IDE) controller to control the HDD 121 and ODD 122. Further, the south bridge 119 has a function for controlling the TV tuner 123 and a function for controlling access to the BIOS-ROM 120.

The HDD 121 is a storage device which stores various software and data. The optical disk drive (ODD) 123 is a drive unit to drive memory media, such as DVDs and CDs, which store video contents. The TV tuner 123 is a receiver to externally receive broadcast program data, such as TV broadcast program.

The network controller 125 is a communication apparatus, which executes communications with an external network, such as the Internet.

The embedded controller/keyboard controller IC (EC/KBC) 124 is a one-chip microcomputer, in which an embedded controller to manage power and a keyboard controller to control the keyboard (KB) 13 and the touch pad 16 are integrated. The embedded controller (EC) has a function for performing a resume operation by powering on the computer 10 in accordance with the operation on the power button 14 by the user, and a function for performing and inhibiting the automatic resume processing depending on the state of the automatic resume inhibit switch 18, and has a function for performing and inhibiting the automatic boot up processing depending on the state of the automatic boot up inhibit switch 18′.

The power supply controller (PSC) 128 generates and supplies power necessary to the respective components of the computer 10 based on power from the battery 126 or external power externally supplied through the AC adapter 127 in accordance with instructions from the embedded controller (EC).

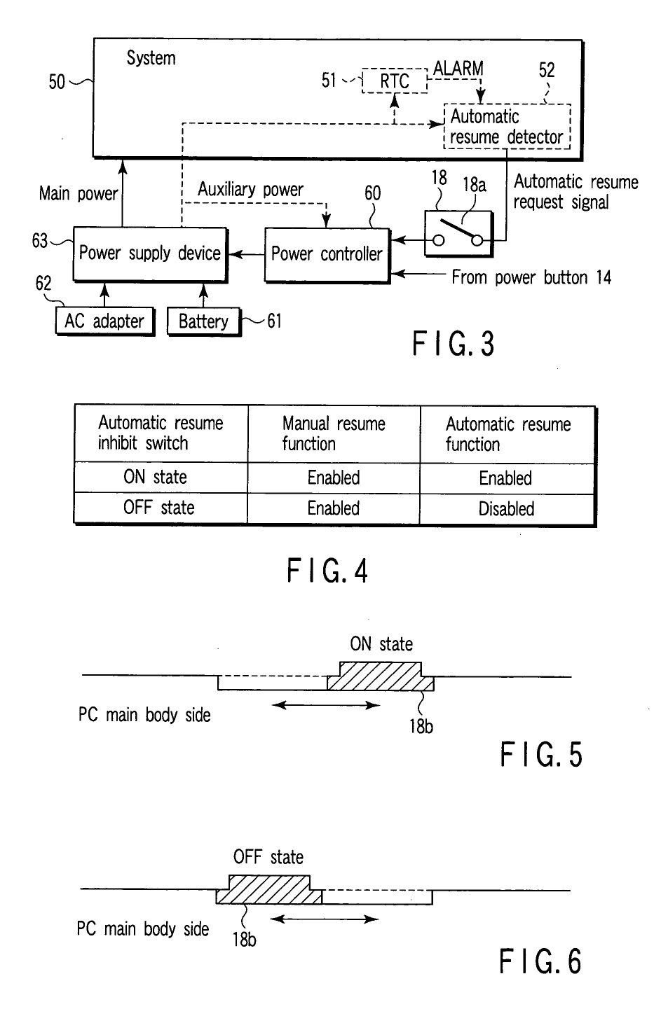

A configuration of an information processing apparatus according to resume processing of this embodiment will be described with reference to FIGS. 3 through 11.

FIG. 3 is a block diagram showing a first configuration example of a part relating to resume processing in the computer 10. A power controller 60, a battery 61, an AC adapter 62, and a power supply device 63 shown in FIG. 3 respectively correspond to the embedded controller (EC), the battery 126, the AC adapter 127 and the PSC 128 shown in FIG. 2.

The computer 10 has a manual resume function, which causes the system to be restored according to a manual power-on operation, and an automatic resume function, which causes the system to be automatically restored when a predetermined condition is satisfied (for example, when a current time coincides with a preset time). The automatic resume function is implemented by, for example, a scheduler.

The power supply device 63 is powered by the battery 61 or the AC adapter 62. It supplies main power to a system 50, etc. when the computer 10 is powered on. The system 50 corresponds to the components (including the CPU and the main memory necessary to execute the OS or various applications) operated by the main power supplied from the power supply device 63.

Even if the computer 10 is not powered on, the power supply device 63 can continuously supply auxiliary power to a real time clock (RTC) 51, an automatic resume detector 52 and a power controller 60, as far as the power source is effective.

The RTC 51 is operated by the auxiliary power supplied from the power supply device 63. It has an alarm function as well as a time measuring function as a clock. The alarm function causes the RTC 51 to output an alarm signal when a measurement value coincides with a set date and time.

The automatic resume detector 52 is operated by the auxiliary power supplied from the power supply device 63. When it detects an alarm signal output from the RTC 51 (when the current time coincides with the present time) or it receives a call from a predetermined device (call from a 3G module or the like), it outputs an automatic resume request signal to request resume processing.

The automatic resume inhibit switch 18, interrupter, enables or disables the automatic resume function. It can selectively set an OFF state of disabling the automatic resume function and an ON state of enabling the automatic resume function. In the ON state, a connecting portion 18a in the switch 18 is closed, so that the automatic resume request signal is transmitted to the power controller 60. In the OFF state, the connecting portion 18a is open, so that the automatic resume inhibit switch 18 inhibits the automatic resume request signal from transmitting to the power controller 60.

Specifically, as shown in FIG. 4, when the automatic resume inhibit switch 18 is in the ON state (when the connecting portion 18a is closed), both the manual resume function and the automatic resume function of this computer are enabled. On the other hand, when the automatic resume inhibit switch 18 is in the OFF state (when the connecting portion 18a is open), the manual resume function is enabled but the automatic resume function is disabled in this computer.

In the automatic resume inhibit switch 18, for example, a member 18b is slid in accordance with the user's operation, as shown in FIGS. 5 and 6, so that the switch 18 can bring the ON state and the OFF state. The automatic resume inhibit switch 18 is not limited to the form shown in FIGS. 5 and 6. It may be of any form as far as it can bring the ON state and the OFF state.

The power controller 60 is operated by the auxiliary power supplied from the power supply device 63. It instructs the power supply device 63 to supply main power to the system 50 in accordance with the operation of the power button 14 by the user or the automatic resume request transmitted through the automatic resume inhibit switch 18. Thus, it executes resume processing.

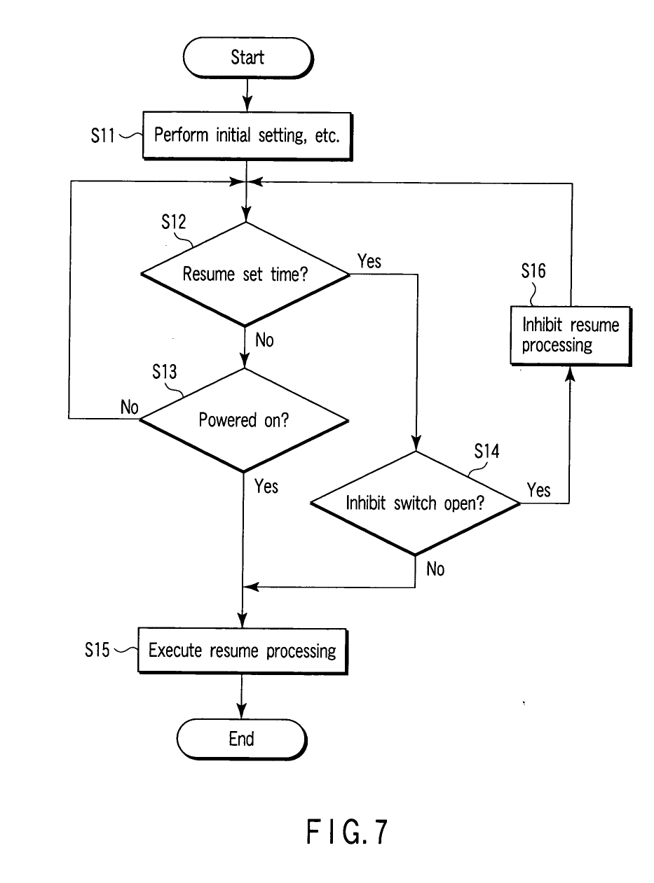

An operation flow of the first configuration example (FIG. 3) will now be described with reference to the flowchart shown in FIG. 7.

In the computer 10, various items relating to the resume function, such as an alarm date and time in the RTC 51, are set in advance (block S11). For example, if the resume function is implemented by the scheduler, setting of the scheduler is performed.

In the state where the computer 10 is powered off, the automatic resume detector 52 monitors whether the RTC 51 generates an alarm (or whether a predetermined device issues a call) (block S12). On the other hand, the power controller 60 monitors whether the power button 14 is depressed (block S13).

These monitoring processes are continuously performed until an alarm from the RTC 51 or a depression of the power button 14 is detected (NO in block S12 and NO in block S13).

If the power button 14 is depressed (YES in block S13), the power controller 60 instructs the power supply device 63 to supply main power to the system 50, thereby executing the resume processing (block S15).

If an alarm is generated from the RTC 51 (or the predetermined device issues a call) (YES in block S12), the automatic resume detector 52 detects the alarm, and issues the automatic resume request signal to the power controller 60.

If the automatic resume inhibit switch 18 is closed (in the ON state) (NO in block S14), the automatic resume request signal is transmitted to the power controller 60. When the power controller 60 detects the automatic resume request signal, it instructs the power supply device 63 to supply main power to the system 50. Thus, the resume processing is executed (block S15). On the other hand, if the automatic resume inhibit switch 18 is open (in the OFF state) (YES in block S14), the automatic resume request signal is not transmitted to the power controller 60. Thus, the resume processing is inhibited (block S16).

According to this example, if the user wishes to disable the automatic resume function, the automatic resume function can be easily inhibited simply by switching the automatic resume inhibit switch 18 from the ON state to the OFF state. Further, the automatic resume function can be enabled again by a simple operation.

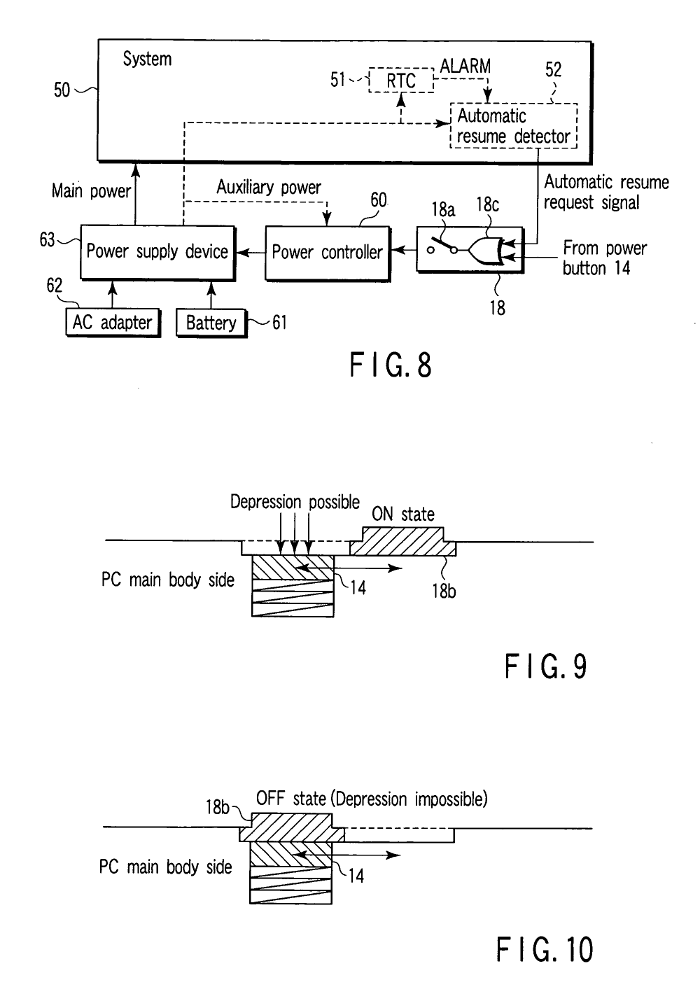

FIG. 8 shows a second configuration example (modification), which differs from the first configuration example shown in FIG. 3. In the following, elements that are different from those shown in FIG. 3 will be described.

The configuration example of FIG. 8 differs from that of FIG. 3 in structure of the automatic resume inhibit switch 18. In this example, as shown in FIG. 8, the automatic resume inhibit switch 18 has an OR circuit 18 connected in series to a connecting portion 18a.

The automatic resume inhibit switch 18 of the configuration example shown in FIG. 8 can also enable or disable the automatic resume function. It can selectively set the OFF state of disabling the automatic resume function and the ON state of enabling the automatic resume function.

In the ON state, the connecting portion 18a in the switch 18 is closed, so that the automatic resume request signal or an operation signal of the power button 14 is transmitted to the power controller 60.

In the OFF state, the connecting portion 18a is open, so that the automatic resume inhibit switch 18 inhibits the automatic resume request signal from transmitting to the power controller 60. Further, in this example, the automatic resume inhibit switch 18 also inhibits an operation signal of the power button 14 from transmitting to the power controller 60 in the OFF state. This is the difference from the example shown in FIG. 3.

The configuration shown in FIG. 8 prevents the resume function from being unintentionally executed, even if the power button 14 is depressed by mistake when the automatic resume inhibit switch 18 is set in the OFF state.

To prevent the resume function from being unintentionally executed, a mechanism to make depression of the power button 14 physically impossible may be used instead of the OR circuit 18c in the circuit configuration of the automatic resume inhibit switch 18 as shown in FIG. 8. For example, configurations as shown in FIGS. 9 and 10 may be adopted, in which the power button 14 is allowed to be depressed in the ON state and a member 18b prevents the power button 14 from being depressed in the OFF state.

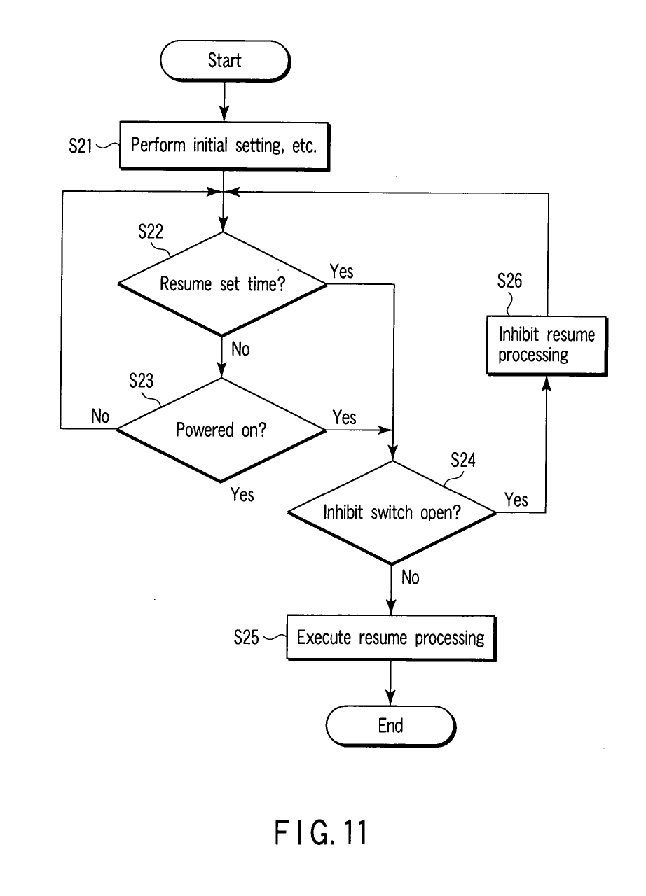

An operation flow of the second configuration example (FIG. 8) with reference to the flowchart shown in FIG. 11.

In the computer 10, various items relating to the resume function, such as an alarm date and time in the RTC 51, are set in advance (block S21). For example, if the resume function is implemented by the scheduler, setting of the scheduler is performed.

In the state where the computer 10 is powered off, the automatic resume detector 52 monitors whether the RTC 51 generates an alarm (or whether a predetermined device issues a call) (block S22). The power controller 60 monitors whether the power button 14 is depressed (block S23).

These monitoring processes are continuously performed until an alarm from the RTC 51 or a depression of the power button 14 is detected (NO in block S22 and NO in block S23).

In the case where the RTC 51 generates an alarm (or the predetermined device issues a call) (YES in block S22) or the power button 14 is depressed (YES in block S23), if the automatic resume inhibit switch 18 is closed (in the ON state) (NO in block S24), the automatic resume request signal or operation signal of the power button 14 is transmitted to the power controller 60. When the power controller 60 detects the automatic resume request signal of the operation signal of the power button 14, it instructs the power supply device 63 to supply main power to the system 50, and executes the resume processing (block S25).

On the other hand, in the case where the RTC 51 generates an alarm (or the predetermined device issues a call) (YES in block S22) or the power button 14 is depressed (YES in block S23), if the automatic resume inhibit switch 18 is open (in the OFF state) (YES in block S24), the automatic resume request signal or operation signal of the power button 14 is not transmitted to the power controller 60. Thus, the resume processing is inhibited (block S26).

According to this example, the automatic resume function can be easily inhibited simply by switching the automatic resume inhibit switch 18 from the ON state to the OFF state. This example has an additional advantage that even if the power button 14 is depressed by mistake when the automatic resume inhibit switch 18 is set in the OFF state, the resume function is prevented from being unintentionally executed.

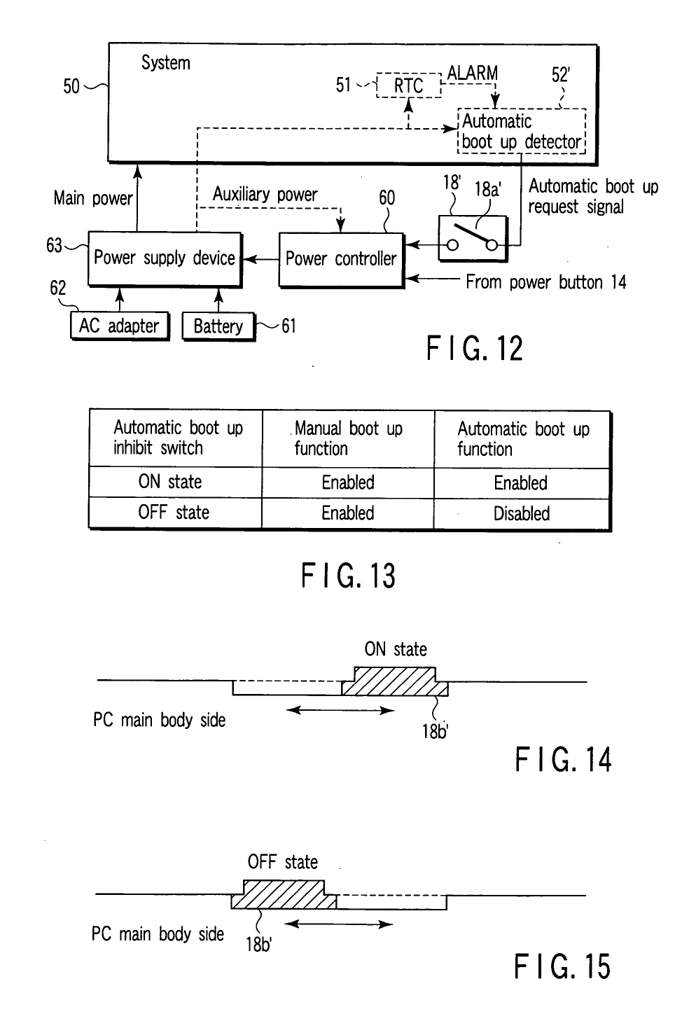

An operation and configuration of the embodiment according to the automatic boot up operation will be described with reference to FIGS. 12 through 20.

FIG. 12 is a block diagram showing a third configuration example of a part relating to resume processing in the computer 10. A power controller 60, a battery 61, an AC adapter 62, and a power supply device 63 shown in FIG. 12 respectively correspond to the embedded controller (EC), the battery 126, the AC adapter 127 and the PSC 128 shown in FIG. 2.

The computer 10 has a manual power-on function, which causes the system to be operable state in response to manually operate the power button 14, and an automatic boot up function, which causes the system to be automatically boot up when a predetermined condition is satisfied (for example, when a current time coincides with a preset time.

The power supply device 63 is powered by the battery 61 or the AC adapter 62. It supplies main power to a system 50, etc. when the computer 10 is powered on. The system 50 corresponds to the components (including the CPU and the main memory necessary to execute the OS or various applications) operated by the main power supplied from the power supply device 63.

Even if the computer 10 is not powered on, the power supply device 63 can continuously supply auxiliary power to a real time clock (RTC) 51, an automatic resume detector 52 and a power controller 60, as far as the power source (e.g. battery 61, AC adapter 62) is effective.

The RTC 51 is operated based on the auxiliary power supplied from the power supply device 63. It has an alarm function as well as a time measuring function as a clock. The alarm function causes the RTC 51 to output an alarm signal when a measurement value coincides with a set date and time.

The automatic boot up detector 52′ is operated based on the auxiliary power supplied from the power supply device 63. When it detects an alarm signal output from the RTC 51 (when the current time coincides with the present time) or it receives a call from a predetermined device (call from a 3G module or the like), it outputs an automatic boot up request signal to request boot up processing.

The automatic boot up inhibit switch 18′ enables or disables the automatic boot up function. It can selectively set an OFF state of disabling the automatic boot up function and an ON state of enabling the automatic boot up function. In the ON state, a connecting portion 18a′ within the switch 18′ is closed, so that the automatic boot up request signal is transmitted to the power controller 60. In the OFF state, the connecting portion 18a′ is open, so that the automatic boot up inhibit switch 18′ inhibits the automatic boot up request signal from transmitting to the power controller 60.

Specifically, as shown in FIG. 13, when the automatic boot up inhibit switch 18′ is in the ON state (when the connecting portion 18a′ is closed), both the manual power-on function and the automatic boot up function of this computer are enabled. On the other hand, when the automatic boot up inhibit switch 18′ is in the OFF state (when the connecting portion 18a′ is open), the manual power-on function is enabled but the automatic boot up function is disabled in this computer.

In the automatic boot up inhibit switch 18′, for example, a member 18b, as shown in FIGS. 14 and 15, is slid in accordance with the user's operation so that the automatic boot up inhibit switch 18′ can bring the ON state and the OFF state. The automatic boot up inhibit switch 18′ is not limited to the form shown in FIGS. 14 and 15. It may be of any form as far as it can bring the ON state and the OFF state.

The power controller 60 is supplied the auxiliary power from the power supply device 63 and instructs the power supply device 63 to supply main power to the system 50 in accordance with the operation of the power button 14 by the user or the automatic boot up request transmitted through the automatic boot up inhibit switch 18′. Thus, the power controller 60 executes boot up processing.

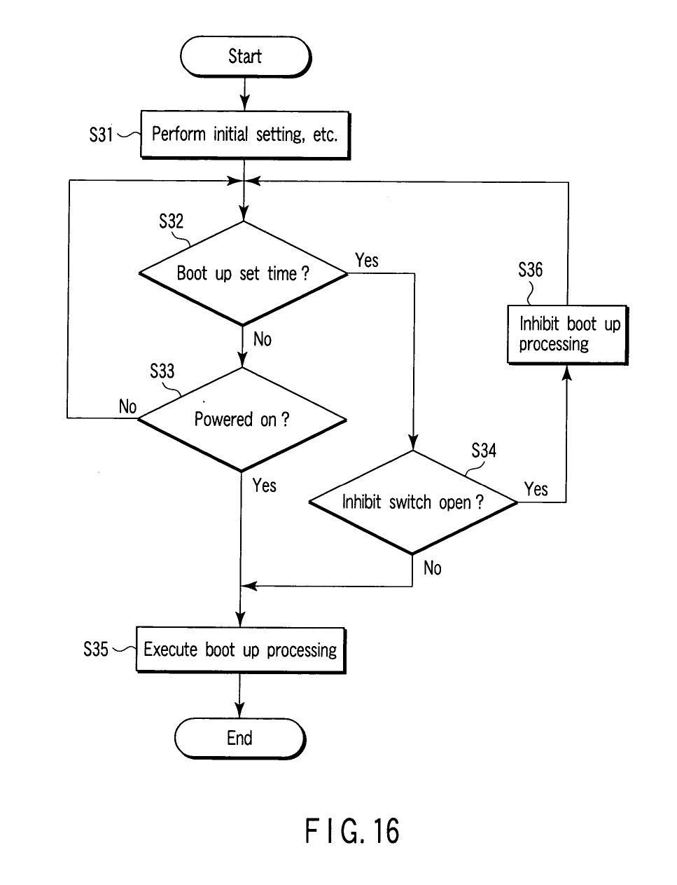

An operation flow of the third configuration example (FIG. 12) will now be described with reference to the flowchart shown in FIG. 16.

In the computer 10, various items relating to the resume function, such as an alarm date and time in the RTC 51, are set in advance (block S31).

In the state where the computer 10 is powered off, the automatic boot up detector 52′ monitors whether the RTC 51 generates an alarm (or whether a predetermined device issues a call) (block S32). On the other hand, the power controller 60 monitors whether the power button 14 is depressed (block S33).

These monitoring processes are continuously performed until an alarm from the RTC 51 or a depression of the power button 14 is detected (NO in block S32 and NO in block S33).

If the power button 14 is depressed (YES in block S33), the power controller 60 instructs the power supply device 63 to supply main power to the system 50, thereby executing the boot up processing (block S35).

If an alarm is generated from the RTC 51 (or the predetermined device issues a call) (YES in block S32), the automatic boot up detector 52′ detects the alarm, and issues the automatic resume request signal to the power controller 60.

If the automatic boot up inhibit switch 18′ is closed (in the ON state) (NO in block S34), the automatic boot up request signal is transmitted to the power controller 60. When the power controller 60 detects the automatic boot up request signal, it instructs the power supply device 63 to supply main power to the system 50. Thus, the boot up processing is executed (block S35). On the other hand, if the automatic boot up inhibit switch 18′ is open (in the OFF state) (YES in block S34), the automatic boot up request signal is not transmitted to the power controller 60. Thus, the boot up processing is inhibited (block S36).

According to this example, if the user wishes to disable the automatic boot up function, the automatic boot up function can be easily inhibited simply by switching the automatic boot up inhibit switch 18′ from the ON state to the OFF state. Further, the automatic boot up function can be enabled again by a simple operation.

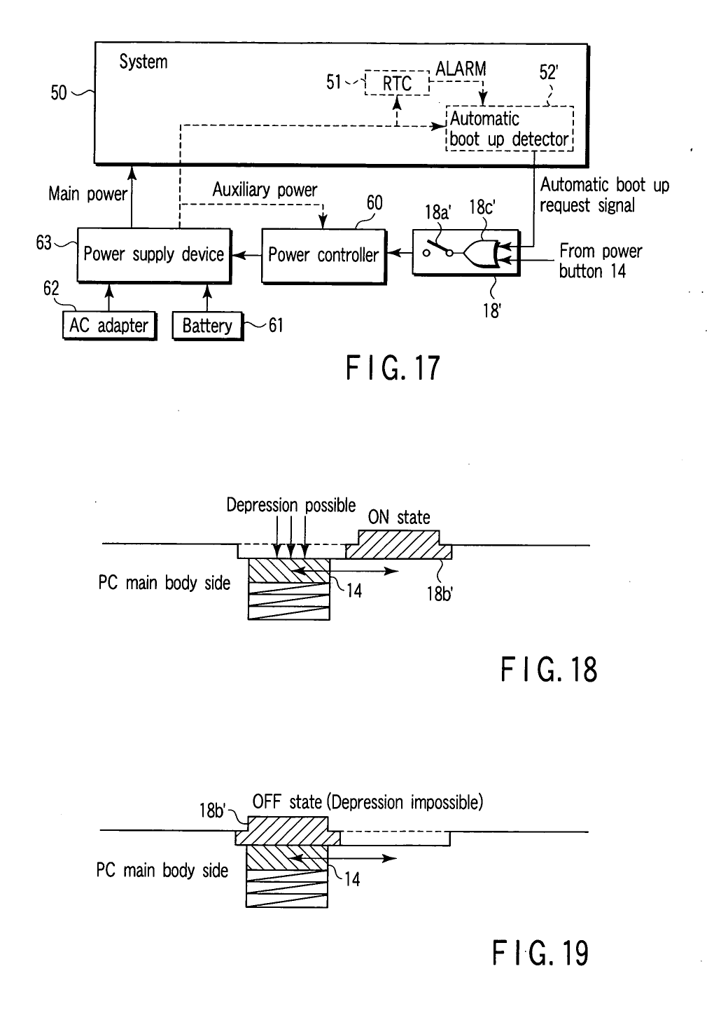

FIG. 17 shows a fourth configuration example (modification), which differs from the third configuration example shown in FIG. 12. In the following, elements that are different from those shown in FIG. 12 will be described.

The configuration example of FIG. 17 differs from that of FIG. 12 in structure of the automatic boot up inhibit switch 18′. In this example, as shown in FIG. 17, the automatic boot up inhibit switch 18′ has an OR circuit 18c connected in series to a connecting portion 18a′.

The automatic boot up inhibit switch 18′ of the configuration example shown in FIG. 17 can also enable or disable the automatic boot up function. It can selectively set the OFF state of disabling the automatic boot up function and the ON state of enabling the automatic boot up function.

In the ON state, the connecting portion 18a′ in the switch 18′ is closed, so that the automatic boot up request signal or an operation signal of the power button 14 is transmitted to the power controller 60.

In the OFF state, the connecting portion 18a′ is open, so that the automatic resume inhibit switch 18 inhibits the automatic boot up request signal from transmitting to the power controller 60. Further, in this example, the automatic boot up inhibit switch 18′ also inhibits an operation signal of the power button 14 from transmitting to the power controller 60 in the OFF state. This is the difference from the example shown in FIG. 12.

The configuration shown in FIG. 17 prevents the boot up function from being unintentionally executed, even if the power button 14 is depressed by mistake when the automatic boot up inhibit switch 18′ is set in the OFF state.

To prevent the boot up function from being unintentionally executed, a mechanism to make depression of the power button 14 physically impossible may be used instead of the OR circuit 18c in the circuit configuration of the automatic boot up inhibit switch 18′ as shown in FIG. 17. For example, configurations as shown in FIGS. 18 and 19 may be adopted, in which the power button 14 is allowed to be depressed in the ON state and a member 18b prevents the power button 14 from being depressed in the OFF state.

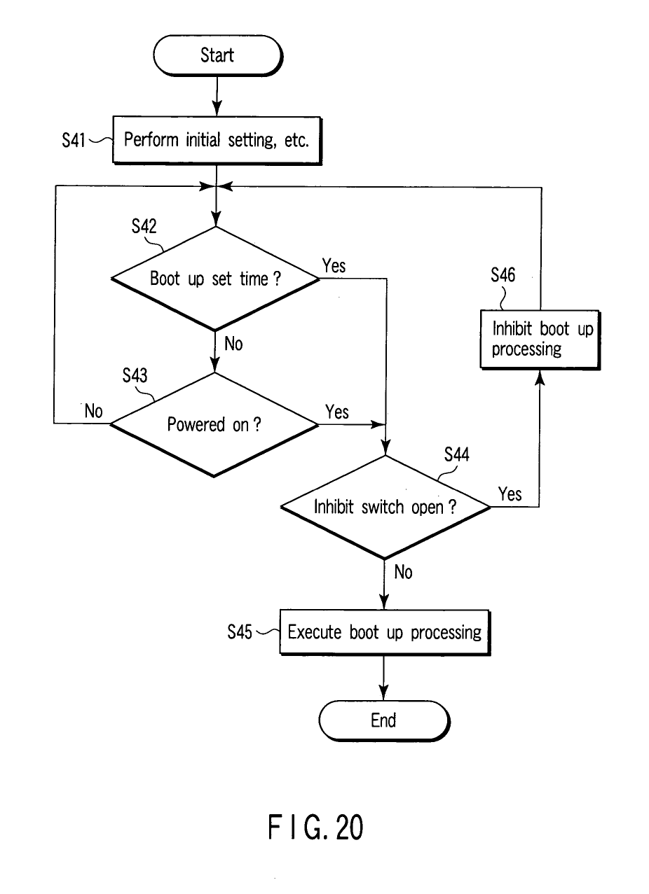

An operation flow of the fourth configuration example (FIG. 17) with reference to the flowchart shown in FIG. 20.

In the computer 10, various items relating to the boot up function, such as an alarm date and time in the RTC 51, are set in advance (block S41).

In the state where the computer 10 is powered off, the automatic boot up detector 52′ monitors whether the RTC 51 generates an alarm (or whether a predetermined device issues a call) (block S42). The power controller 60 monitors whether the power button 14 is depressed (block S43).

These monitoring processes are continuously performed until an alarm from the RTC 51 or a depression of the power button 14 is detected (NO in block S42 and NO in block S43).

In the case where the RTC 51 generates an alarm (or the predetermined device issues a call) (YES in block S42) or the power button 14 is depressed (YES in block S43), if the automatic boot up inhibit switch 18′ is closed (in the ON state) (NO in block S44), the automatic boot up request signal or operation signal of the power button 14 is transmitted to the power controller 60. When the power controller 60 detects the automatic boot up request signal of the operation signal of the power button 14, it instructs the power supply device 63 to supply main power to the system 50, and executes the boot up processing (block S45).

On the other hand, in the case where the RTC 51 generates an alarm (or the predetermined device issues a call) (YES in block S42) or the power button 14 is depressed (YES in block S43), if the automatic boot up inhibit switch 18′ is open (in the OFF state) (YES in block S44), the automatic boot up request signal or operation signal of the power button 14 is not transmitted to the power controller 60. Thus, the boot up processing is inhibited (block S46).

According to this example, the automatic boot up function can be easily inhibited simply by switching the automatic boot up inhibit switch 18′ from the ON state to the OFF state. This example has an additional advantage that even if the power button 14 is depressed by mistake when the automatic boot up inhibit switch 18′ is set in the OFF state, the boot up function is prevented from being unintentionally executed.

As has been described above in detail, the automatic resume function can be easily switched between the enabled or disabled states.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a controller configured to permit an automatic power-on of the apparatus; and
a device configured to be manually operated to interrupt the automatic power-on of the apparatus.

2. The information processing apparatus according to claim 1, wherein the controller is configured to permit an automatic power-on of the apparatus when a predetermined condition is satisfied.

3. The information processing apparatus according to claim 1, further comprising a housing for enclosing at least a portion of said apparatus and wherein the device is positioned on the housing.

4. The information processing apparatus according to claim 1, wherein the device is configured to prevent a manual power-on of the apparatus.

5. The information processing apparatus according to claim 4, wherein the device is configured to enable both the manual power-on of the apparatus and the automatic power-on of the apparatus.

6. The information processing apparatus according to claim 1, wherein the controller is configured to permit an automatic power-on of the apparatus in response to a signal transmitted remotely.

7. The information processing apparatus according to claim 6, wherein the signal is transmitted from a 3G module.

8. A power-on control method applied to an information processing apparatus, the method comprising:
enabling an automatic power-on function that is configured to power-on the apparatus; and
manually setting a device positioned on a housing of the apparatus to interrupt the automatic power-on of the apparatus.

9. The power-on control method according to claim 8, wherein the information processing apparatus further comprises a manual power-on function that powers on the apparatus in response to a manual power-on operation, and wherein the method further comprises manually setting the device to interrupt both the manual power-on function and the automatic power-on function.

10. The power-on control method according to claim 9, further comprising manually setting the device to be in a second state to enable the manual power-on function and disable the automatic power-on function.
